(19) United States
(12) Patent Application Publication
(10) Pub. No.: US 2001/0019596 A1
(43) Pub. Date: Sep. 6, 2001

(54) Method and device for measuring a transverse dimension of a spacer-grid of a nuclear fuel assembly

(76) Inventors: Jairo Arias, Genas (FR); Michel Brin, Bourgoin-Jallieu (FR); Michel Pain, Chorey (FR)

Correspondence Address: Connolly Bove Lodge & Hutz LLP, Suite 800, 1990 M Street, N.W., Washington, DC, 20036-3425, US

(21) Appl. No.: 09/780,564

(22) Filed: Feb. 12, 2001

(30) Foreign Application Priority Data
Feb. 11, 2000 (FR) 00 01754

(51) Int. Cl. G21C 17/00

(52) U.S. Cl. 376/245

(57) ABSTRACT

A measuring tool (10) comprising two jaws (15b, 15c) which can be moved one with respect to the other in a first horizontal direction and moved back towards each other by an elastic means, is set up level with the spacer-grid (3) of the fuel assembly. The measuring tool (10) is displaced in a second horizontal direction perpendicular to the first horizontal direction and to a front face (6a) of the spacer-grid (3) such that the jaws (15b, 15c) each come into contact with a lateral face (6b, 6c) of the spacer-grid (3) and the distance between the jaws (15b, 15c) is measured in the first horizontal direction. The tool (10) is mounted so as to rotate freely about an axis parallel to the vertical longitudinal direction of the fuel assembly (1) such that the measuring tool (10) is oriented freely with respect to the front face (6a) of the spacer-grid (3), when the measuring tool is displaced in the second horizontal direction. After having engaged the jaws (15b, 15c) on the lateral faces (6b, 6c) of the spacer-grid (3), the measuring tool (10) is made to rotate about a horizontal axis perpendicular to the front face (6a) of the spacer-grid (3). Measurements are made while the measuring tool (10) rotates and the minimum value of the separation of the jaws (15b, 15c) is determined, which forms the measurement of the transverse dimension of the spacer-grid (3).

The invention relates to a method and a device for measuring a transverse dimension of a spacer-grid of a fuel assembly and, in particular, of a fuel assembly for a pressurized water nuclear reactor.

Fuel assemblies for water-cooled reactors and, in particular, fuel assemblies for pressurized water-cooled reactors, generally comprise a bundle of fuel rods, each rod consisting of a stack of fuel pellets inside a tubular envelope, and a framework for holding the fuel rods, comprising spacer-grids distributed over the longitudinal direction of the rod bundle, guide tubes arranged in certain rod positions inside the bundle and two end nozzles.

When the nuclear reactor is in service, the fuel assemblies are subjected to irradiation which is responsible for certain modifications in the structure and dimensions of the components of the fuel assembly framework.

In particular, the fuel assembly spacer-grids, which comprise an array of cells bounded by grid straps and a peripheral frame of prismatic shape which may have, for example, a square cross section, are subject, when irradiated in the core of the nuclear reactor, to growth which results in an increase in the transverse dimension of the spacer-grid. For example, the length of the side of the square cross section of the grid may become substantially greater than the nominal length of the side of the grid in the new state.

The growth of the spacer-grids subjected to irradiation may have drawbacks when refuelling the core of a nuclear reactor with assemblies which have been irradiated during a previous period of nuclear reactor operation and which are placed, during refuelling, in a new region of the core.

Because of the growth of the spacer-grids, setting up fuel assemblies in adjacent-positions inside the core of the nuclear reactor could be made difficult or impossible, at least for certain fuel assemblies.

Furthermore, the growth of the spacer-grids results in a growth and a deformation of the grid cells, such that there is a risk that the fuel rods can no longer be held effectively. Altering the size of the free spaces between the rods and the grid components may also alter the thermohydraulic behaviour of the feel assembly.

It may therefore be necessary to ascertain accurately the transverse dimensions of the spacer-grids of the irradiated fuel assemblies which have been taken out of the core of a nuclear reactor, during a phase when the nuclear reactor has been shut down for refuelling, maintenance and repair.

The assemblies taken out of the nuclear reactor core are conveyed to a fuel cooling pool inside which the fuel assemblies can be monitored, repaired and stored under a depth of water sufficient to provide biological protection to the operators responsible for this work.

It has been proposed to measure the transverse dimensions of the spacer-grids of the fuel assemblies inside the fuel pool, the fuel assembly, which can be placed in a fuel elevator or suspended by a lifting means, being arranged such that its longitudinal axis is vertical.

It has been proposed, for example, to use a tool for measuring the transverse dimensions of the fuel assembly spacer-grids, produced in the form of a large slide calliper having two jaws which can be moved one with respect to the other and which can be displaced by one or two cylinders, so that they can move towards or away from each other. The jaws are opened by actuating the cylinders in order to engage the tool on two lateral faces of the external frame of the spacer-grid to be measured on both sides of the front face, the transverse dimension of which is measured, then the jaws are closed so as to put them in contact with the two lateral faces of the frame and the separation of the jaws of the measuring tool is measured.

This method makes it possible to obtain quite good accuracy but the device used is complex and setting it up on the spacer-grid requires lengthy and tricky operations.

In addition, there are significant risks of damaging the rods of the fuel assembly and the framework when engaging the jaws of the measuring tool on the frame of the spacer-grid.

FR-A-2,607,244 therefore proposed a device and a method for measuring the transverse dimension of spacer-grids by using ultrasound transmitters-receivers which have to be placed opposite the lateral faces of the spacer-grid on which the measurement is being carried out. This device, which comprises means for analysing the signals from the transmitters-receivers, may be relatively complex and expensive. In addition, in the case of some grids of recent design, the grid straps making up the frame of the grids comprise numerous openings, such that it is very difficult to place the ultrasound sensors facing perfectly plane surfaces of the grid frame. Perfectly plane surfaces of large enough dimensions are needed in order to use ultrasound measurement.

The purpose of the invention is therefore to propose a method for measuring a transverse dimension of a spacer-grid of a fuel assembly comprising a bundle of fuel rods and a framework for holding the fuel rods, consisting of spacer-grids distributed over a longitudinal direction of the rod bundle, guide tubes arranged in certain rod positions inside the bundle and end nozzles, the measurement being carried out under water in a pool in which the fuel assembly is placed with a longitudinal axis in a vertical arrangement, on the spacer-grid which comprises a frame of right prismatic shape with a polygonal cross section, comprising a first vertical front face, the transverse horizontal dimension of which is measured, and two lateral faces on both sides of the front face, the measurement method consisting in setting up, level with the spacer-grid, a measuring tool comprising two jaws which can be moved one with respect to the other in a first horizontal direction, such that the first horizontal direction is substantially parallel to the front face of the spacer-grid and that the jaws each come into contact with a lateral face of the spacer-grid and that the distance between the jaws is measured in the first horizontal direction, this method making it easier to set up the measuring tool, without risking damage to the fuel assembly, on all types of fuel assembly, whatever the embodiment of the spacer-grid.

For this purpose:

the measuring tool is displaced in a second horizontal direction perpendicular to the first horizontal direction and to the front face of the spacer-grid, such that the tool which is mounted so as to rotate freely about a vertical axis, is oriented freely with respect to the front face of the spacer-grid and that the jaws moved back towards each other by an elastic return means each come to bear on a lateral face of the spacer-grid,

the measuring tool is made to rotate about a second horizontal axis perpendicular to the first and the distance between the jaws is measured remotely by an electromagnetic sensor while the measuring tool rotates, and

the minimum value of the separation of the jaws is determined while the measuring tool rotates, this minimum value making up the measurement of the transverse dimension of the spacer-grid.

In order to understand the invention better, one embodiment of a measuring device and the implementation of a measuring method according to the invention on a spacer-grid of a fuel assembly of a pressurized water nuclear reactor will now be described with reference to the figures, by way of an example.

FIG. 1 is a top view in section through a horizontal plane of a fuel assembly and of a tool for measuring the transverse dimension of a spacer-grid of the fuel assembly.

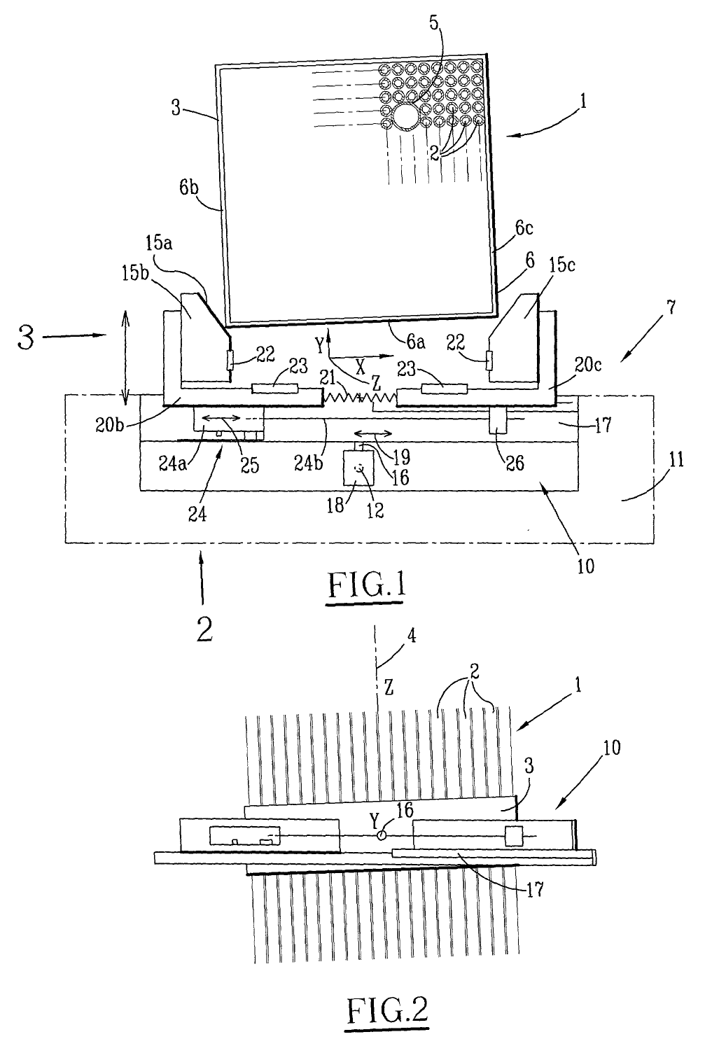

FIG. 2 is a front view along 2 of FIG. 1.

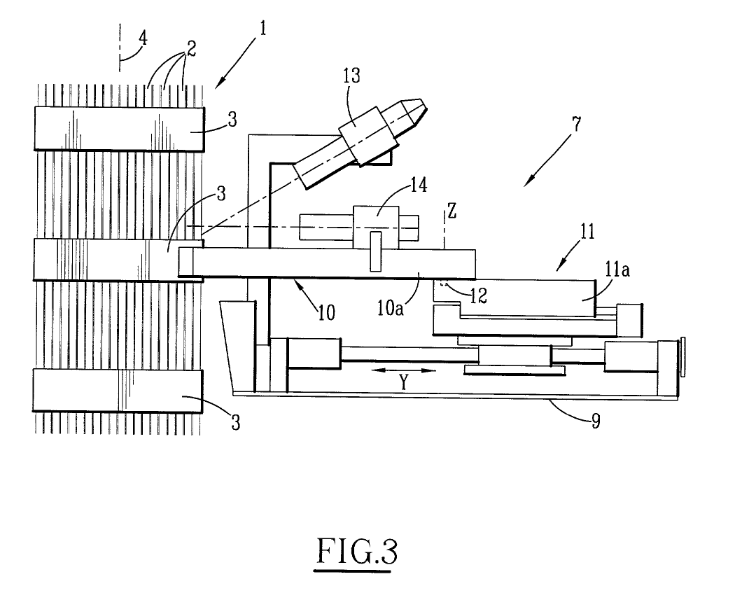

FIG. 3 is a side view along 3 of FIG. 1.

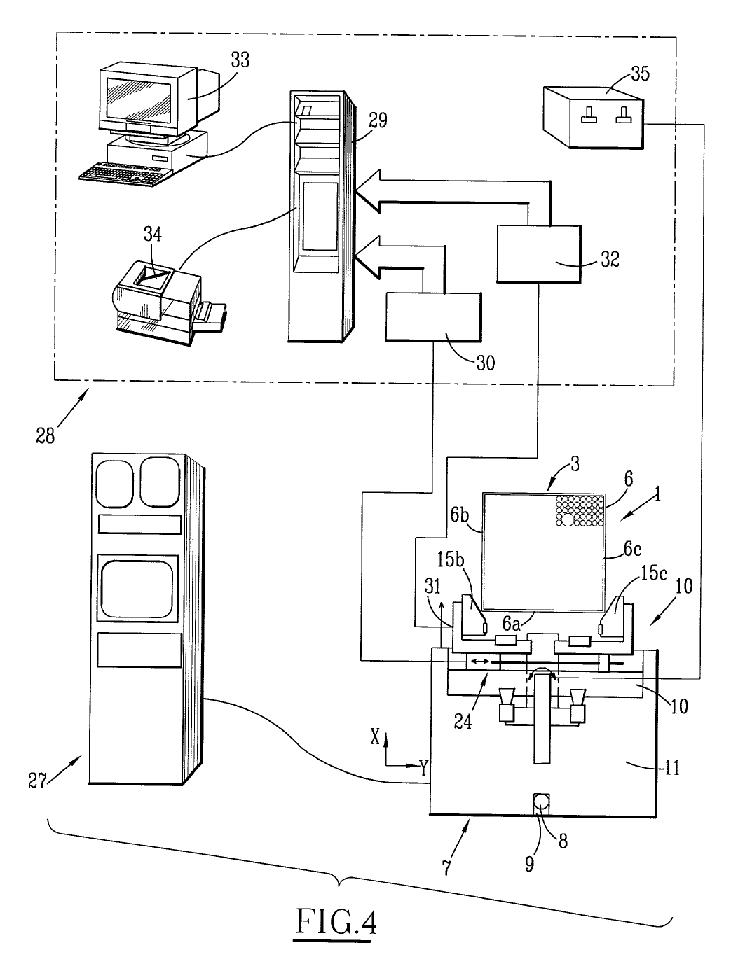

FIG. 4 is a schematic view of the facility for measuring the transverse dimension of the spacer-grids, according to the invention.

FIGS. 1, 2 and 3 show a fuel assembly of a pressurized water-cooled nuclear reactor denoted in general by the reference number 1, which comprises fuel rods 2 contained inside a framework, in the form of a bundle in which the rods are all parallel to each other and have cross sections arranged in a regular array (as can be seen in FIG. 1).

The framework of the fuel assembly comprises spacer-grids 3 distributed, with regular spacing, over the axial longitudinal direction 4 of the fuel assembly and guide tubes 5 replacing certain fuel rods in the bundle and providing the connection between the spacer-grids 3. In addition, the framework comprises fuel assembly end nozzles which are attached to the end of the guide tubes 5 on each side of the longitudinal ends of the fuel rod bundle 2 (not shown).

The spacer-grids 3 include an external frame 6 of right prismatic shape having a square cross section.

The fuel rods 2 are held inside cells of the spacer-grids 3 bounded by intersecting grid straps of the spacer-grid, by springs and bosses projecting from the walls of the cells.

For the purpose of simplification, neither the walls of the cells nor the springs and bosses holding the rods have been shown in FIG. 1.

In order to measure the transverse dimension of a spacer-grid 3 of the fuel assembly 1, that is to say, to accurately measure the length of one side of the frame 6 of the spacer-grid, a measuring facility 7 is used, which is implemented inside a pool and generally inside the fuel cooling pool of a nuclear power station.

The fuel assembly 1, in the measuring position, as shown in the figures, is arranged vertically, that is to say with its longitudinal axis 4 parallel to the rods 2 of the bundle, in a vertical arrangement.

The fuel assembly may, for example, be placed in a handling means of the cooling pool, such as a fuel elevator, which also allows the measuring facility 7 to be displaced in the vertical direction in order to measure the dimension of any spacer-grid over the height of the fuel assembly.

The measuring facility 7 comprises a plate 9 which is connected, by an attachment means 8, to a moveable component of the fuel elevator or to any other means of lifting and handling, such as a lifting mast, so that the measuring facility 7 can be displaced in the vertical direction inside the cooling pool, in which the fuel assembly 1 is arranged with its axis 4 vertical.

The measuring facility 7 comprises a measuring tool 10 carried by a compound table 11 allowing the measuring device 10 to be displaced in two horizontal directions, so that the measuring device 10 can engage with the frame 6 of the spacer-grid 3 on which the measurement is being carried out.

A first horizontal direction X of displacement of the table 11 (see FIG. 1) is parallel to a front face 6a of the frame 6 of the spacer-grid 3, the length of which it is desired to measure.

A second horizontal direction Y is perpendicular to the direction X and parallel to two lateral faces 6b and 6c of the frame 6 of the grid arranged on each side of the front face 6a.

The direction Z parallel to the axis 4 of the fuel assembly is the vertical direction along which the measuring facility 7 is set up level with a spacer-grid 3.

The compound table 11 comprises a lower table which is displaced in a first horizontal direction on which an upper table 11a is mounted, and which is displaced in a second horizontal direction perpendicular to the first.

The measuring tool 10 is mounted on the upper table 11a via a vertical spindle 12, such that the tool 10 is completely free to rotate about the vertical geometric axis Z on the compound table 11.

In addition, the measuring facility 7 comprises cameras making it possible to set up the measuring facility 7 in a position to measure the transverse dimension of a spacer-grid 3.

A sighting camera 13 makes it possible to set up the measuring facility and in particular the measuring tool 10 level with a spacer-grid 3 on which it is desired to carry out the measurement, for example by controlling the fuel elevator of the cooling pool.

The sighting camera 13 includes a sighting cross-hair and sighting markers are fixed to each of the spacer-grids, so that the measuring facility can be stopped and placed in a measuring position which is satisfactory depending on the type of grid.

A wide angle camera 14 makes it possible to view the measuring tool and, in particular, two jaws 15b and 15c of the measuring tool intended to come into contact with the corresponding lateral faces 6b and 6c of the frame 6 of the spacer-grid 3.

Finally, a camera for sighting the axis of the central rod of the fuel assembly 1 on the front face of the fuel assembly makes it possible to control the movement in the X direction of the compound table 11 in order that the measuring device 10 can be perfectly centred with respect to the fuel assembly and to the spacer-grid 3 on which the measurements are being carried out.

The displacement of the compound table in the Y direction makes it possible to align and set up the measuring device, the jaws 15b and 15c of which come into contact with the lateral faces of the frame 6.

The measuring tool 10 comprises a support-plate 10a which is mounted so as to rotate freely about a vertical axis on the upper stage 11a of the compound table, via the spindle 12 on which a clip 17 for engaging the frame 6 of the grid 3, comprising the jaws 15b and 15c, is mounted so as to rotate via a horizontal spindle 16 and via a motor means 18.

As can be seen in FIGS. 1 and 2, the spindle 16 for rotating the clip 17 about a horizontal axis parallel to the Y direction is secured to the output shaft of a motor means 18, such that it is possible to control the rotation within a limited range, for example, ±8°, of the clip facility 17 comprising the jaws 15b and 15c.

The jaws 15b and 15c are mounted on the clip 17, so that they can be displaced one with respect to the other, in a horizontal direction, within a limited range, as shown conventionally by the arrow 19 in FIG. 1.

For this, the jaws 15b and 15c are secured to respective supports 20b and 20c, at least one of the supports 20b and 20c being mounted so that it can move on the clip 17 via a means such as a slideway.

An elastic return means 21, such as a spring, makes it possible to move the supports 20b and 20c and the jaws 15b and 15c back towards each other, into a position of closest approach as shown in FIG. 1.

The jaws 15b and 15c have an internal engagement part 15a comprising a surface which is inclined so that the engagement space of the frame 6 of the spacer-grid 3 between the jaws 15b and 15c is flared in order to make it easier to engage and guide the jaws 15b and 15c on the lateral faces 6b and 6c of the frame 6 of the spacer-grid 3.

The engagement part 15a of the jaws 15b and 15c also comprises a bearing pad 22 on the corresponding lateral face of the frame 6, it being possible for the pad 22 to be made of a material such as Teflon.

Similarly, the supports 20b and 20c of the jaws 15b and 15c each comprise a bearing pad 23 on the front face 6a of the grid 6. Thus, any damage to the grid during engagement of the measuring device 10 is prevented and the jaws bear perfectly on the lateral faces of the frame 6.

A measuring sensor 24 is attached to the supports 20b and 20c of the jaws 15b and 15c of the clip 17, so as to measure the jaw separation and, more specifically, to determine a change in the jaw 15b and 15c separation with respect to a fixed reference value.

The separation sensor 24, of the electromagnetic type, comprises a sensor body 24a which is mounted on the support 20b of the jaw 15b.

The body 24a of the sensor 24, which is preferably a sensor of the LVDT type, comprises an electromagnetic winding of the solenoid type in which a solenoid plunger secured to a rod 24b having a first end attached to the solenoid plunger and a second end attached to the support 20c of the jaw 15c, is displaced via a connection piece 26.

For example, when measuring pressurized-water nuclear reactor spacer-grids with a square cross section, the side of which has a length of between 180 and 230 mm, the maximum measuring travel of the sensor 24 indicated by the arrow 25 is about 5 mm, the relative displacement of the jaws 15b and 15c having a maximum range of about 25 mm.

As can be seen in FIG. 4, the measuring system used to measure the transverse dimensions of the spacer-grids 3 of a fuel assembly 1 in the vertical position in the cooling pool of a nuclear power station comprises the measuring facility 7 which is immersed in the water of the pool and placed level with the spacer-grid 3 on which the measurements are carried out and viewing, computing, display and control means arranged in a measuring and monitoring region above the upper level of the cooling pool.

These means comprise a control and video camera viewing rack 27 which is connected to the video cameras attached to the measuring facility 7 and which comprises screens for viewing the fuel assembly 1 and the jaws of the measuring tool. The rack 27 also comprises means for controlling the compound table 11.

The control and calculation display means arranged at the upper level of the cooling pool also comprise a measurement acquisition and control rack, denoted generally by the reference 28.

The rack 28 comprises an analogue signal processing and acquisition unit 29 comprising an analogue data input card and an analogue-to-digital conversion module.

The analogue inputs reaching the unit 9 consist of signals from the LVDT sensor 24 of the measuring tool 10, which reach the unit 29 via a conditioning module 30 and the analogue signals coming from a temperature detector 31 dipped in the cooling pool water in the vicinity of the fuel-assembly spacer-grid 3 connected to the unit 29 via a housing 32 for conditioning the signals from the temperature probe. The digital signals output from the unit 29 are sent to a computer 33 which makes it possible to calculate and display the measured values of the transverse dimension of the fuel-assembly spacer-grid 3. The measurements are corrected as a function of the temperature measured by the detector 31.

The signals are also sent to a printer 34 in order to publish measurement values and values calculated from data.

Finally, the rack 28 also comprises a control unit 35 connected to the motor means 18 for rotating the clip 17.

The width of a spacer-grid of a fuel assembly in the vertical position in the cooling pool of the nuclear power station can be measured by the operations which will be described below.

Firstly, the measuring channel is calibrated by engaging the jaws of the measuring tool 10 on two bearing surfaces of a calibration block, the width between the bearing surfaces of which corresponds to the nominal width of a fuel-assembly spacer-grid. The measurement signals obtained from the LVDT sensor(s) are placed in memory.

The measuring facility 7 is lowered into the cooling pool, for example by using a pool fuel elevator, so as to place the measuring tool 10 attached to the compound table 11 in a position and at a level making it possible to measure the width of one of the fuel-assembly spacer-grids 3.

The setting-up of the measuring tool is monitored by the measuring facility cameras. The centring of the measuring tool with respect to the face of the fuel assembly on which the measurements are being made, is refined using the camera for sighting the axis of a central rod of the fuel assembly and the compound table 11.

The displacement of the compound table and of the measuring tool in the Y direction is controlled, so as to engage the jaws 15b and 15c on the lateral sides 6b, 6c of the spacer-grid, straddling the front side 6a on which the width is to be measured.

The displacement of the compound table is controlled and adjusted so as to prevent any possibility of damage to the fuel assembly. In particular, the compound table is designed such that it is not possible to exert a force greater than a certain limit on the spacer-grid and the fuel assembly, during displacements of the measuring tool.

The internal parts of the jaws 15b and 15c come into contact with the edges of the fuel assembly by their inclined surfaces which move away from each other, so as to engage the internal parts of the jaws on the lateral faces 6b and 6c of the frame of the fuel assembly spacer-grid.

At the end of engagement, the jaws 15b and 15c are in contact with the corresponding lateral faces 6b and 6c via the end stops 22 and the supports 20b and 20c are themselves in contact with the front face 16a of the spacer-grid via the end stops 23.

The end stops 22 are placed so as to come into contact with the lateral faces of the frame 6 of the spacer-grid at the second rod cell starting from the front face, between the bosses or springs attached to the external wall of the cell formed by the lateral face of the spacer-grid frame.

When the measuring tool 10 advances in the Y direction and when the measuring tool 10 comes into contact with the front face of the spacer-grid and the fuel assembly, the measuring tool 10 is automatically oriented about a vertical axis Z because the measuring tool 10 is mounted so as to rotate freely on the compound table 11, via the pivot pin 12. Thus, perfect contact between the measuring tool and the front face of the fuel assembly is obtained.

The jaws 15b and 15c are moved back towards each other and in contact with the lateral faces 6b and 6c of the frame 6 of the spacer-grid 3 by the spring 21 which is rated so as to ensure a very good contact while preventing excessive forces being exerted on the lateral faces of the frame 6.

The position of the measuring tool is checked using the wide-angle image acquisition camera and, after checking, the measuring operations are carried out.

During all the operations for measuring the width of the spacer-grid, the position of the jaws with respect to the faces of the grid frame is monitored.

The motor 18 is set in rotation, which causes the clip 17 comprising the jaws 15b and 15c to rotate about the horizontal axis Y. The clip is rotated within a range of about ±80°.

While the clip 17 is rotated, the jaws 15b and 15c, moved back towards each other in the X direction by the spring 21, remain in contact with the lateral faces of the frame 6 of the spacer-grid.

The jaw separation is measured continuously by comparing the signals from the LVDT sensor 24 sent, via the conditioning module 30, to the computer 33 with the calibration data.

The minimum separation measured while the clip 17 is rotating is determined and this minimum separation value of the jaws 15b and 15c, which is considered to be the measured value of the width or the transverse dimension of the frame 6 of the spacer-grid 3, is displayed.

The measuring tool 10 can then be separated from the frame 6 of the spacer-grid 3 by moving the measuring tool away in the Y direction using the compound table 11.

The measuring facility 7 can then be displaced and put into a measuring position on another face of the spacer-grid 3 or on another spacer-grid of the fuel assembly 1 or else in a position for measuring a spacer-grid of a second fuel assembly.

The device according to the invention therefore makes it possible to carry out fast and accurate measurement while making it easy to set up the measuring tool, without risk of damaging the spacer-grid or the fuel assembly, by a method which can be completely automated.

The invention is not limited strictly to the embodiment which has been described.

Thus, the measuring tool may have a different form to that which has been described and the displacement or return means for the various components of the measuring tool may also be produced in a different form.

The invention is applicable, not only to fuel assemblies for a pressurized-water nuclear reactor, but also to other types of fuel assembly, the grids of which may comprise an external frame having a shape other than a square shape.

1. Method for measuring a transverse dimension of a spacer-grid (3) of a fuel assembly (1) comprising a bundle of fuel rods (2) and a framework for holding the fuel rods (2) made up of spacer-grids (3) distributed over a longitudinal direction (4) of the rod bundle, guide tubes (5) arranged in certain rod (2) positions inside the bundle and end nozzles, the measurement being carried out under water in a pool in which the fuel assembly is placed with its longitudinal axis (4) in a vertical arrangement, on the spacer-grid (3) which comprises a frame (6) of right prismatic shape with a polygonal cross section, comprising a first vertical front face (6a), the transverse horizontal dimension of which is measured, and two lateral faces (6b, 6c) on both sides of the front face (6a), the measurement method consisting in setting up, level with the spacer-grid (3), a measuring tool (10) comprising two jaws (15b, 15c) which can be moved one with respect to the other in a first horizontal direction (X), such that the first horizontal direction is substantially parallel to the front face (6a) of the spacer-grid (3) and that the jaws (15b, 15c) each come into contact with a lateral face (6b, 6c) of the spacer-grid (3) and that the distance between the jaws (6b, 6c) is measured in the first horizontal direction (X), characterized:
in that the measuring tool (10) is displaced in a second horizontal direction (Y) perpendicular to the first horizontal direction (X) and to the front face (6a) of the spacer-grid (3), such that the tool (10) which is mounted so as to rotate freely about a vertical axis Z, is oriented freely with respect to the front face (6a) of the spacer-grid (3) and that the jaws (15b, 15c) moved back towards each other by an elastic return means (21) each come to bear on a lateral face (6b, 6c) of the spacer-grid (3),
in that the jaws (15b, 15c) of the measuring tool (10, 17) are made to rotate about a horizontal axis (16) perpendicular to the first horizontal direction and in that the distance between the jaws (15b, 15c) is measured remotely, while the measuring tool (10, 17) rotates, using a sensor (24) of the electromagnetic type, and
in that the minimum value of the distance between the jaws (15b, 15c) is determined while the measuring tool (10, 17) rotates, this minimum value making up the measurement of the transverse dimension of the spacer-grid (3).

2. Method according to claim 1, characterized in that, prior to setting up the measuring tool (10), level with the spacer-grid (3) on which the measurement is carried out, the electromagnetic sensor (24) is calibrated by setting up the jaws (15b, 15c) of the measuring tool (10) to bear on bearing surfaces of a calibration block and by collecting measurement signals from the electromagnetic sensor (24).

3. Method according to either of claims 1 and 2, characterized in that the temperature in the pool is measured, in the vicinity of the spacer-grid (3) of the fuel assembly on which measurements are being carried out and in that the measurements of the separation of the jaws (15b, 15c) of the measuring device are corrected according to the temperature measurement.

4. Device for measuring a transverse dimension of a spacer-grid (3) of a fuel assembly (1) comprising a bundle of fuel rods (2) and a framework for holding the fuel rods made up of spacer-grids (3) distributed over a longitudinal direction of the rod (2) bundle, guide tubes (5) arranged in certain rod (2) positions inside the bundle and two end nozzles, the measurement being carried out under water in a pool in which the fuel assembly is placed with a longitudinal axis (4) in a vertical arrangement, on the spacer-grid (3) which comprises a frame (6) of right prismatic shape comprising a first vertical front face (6a), the transverse horizontal dimension of which is measured and two lateral faces (6b, 6c) on both sides of the front face, the device comprising a measuring tool (10) having two jaws (15b, 15c) which can be moved one with respect to the other in a first horizontal direction (X) and means (24, 29, 33) for measuring the separation of the jaws (15b, 15c) in the first horizontal direction (X) comprising a sensor (24) of the electromagnetic type, characterized in that the measuring tool (10) comprising the jaws (15b, 15c) is mounted so as to rotate freely about a first vertical axis (12) on a support (11, 9) associated with means (11) for displacing the measuring tool in a first and a second horizontal direction (X, Y) and in a vertical direction (Z) and also means (16, 18) to make the jaws (15b, 15c) of the measuring tool (10, 17) rotate about a second horizontal axis (16) along the second horizontal direction (X).

5. Device according to claim 4, characterized in that the support (11) for the measuring tool (10) and the means for displacing the measuring tool (10) in the first and in the second horizontal directions (X, Y) consist of a compound table (11).

6. Device according to either of claims 4 and 5, characterized in that the electromagnetic sensor (24) for measuring the separation of the jaws (15b, 15c) is an LVDT sensor comprising a body made up of an electric winding and a solenoid plunger secured to a rod (24b) of the sensor (24), the body of the sensor being attached to a support (20b) of one of the jaws (15b) and the rod (24b) of the sensor (24) being connected to an end opposite the solenoid plunger of the sensor (24) to a support (20c) of the second jaw (15c).

7. Device according to any one of claims 4 and 5, characterized in that it comprises a measuring facility (7) comprising the measuring tool (10) and its support and displacement means (9, 11) and also at least one facility (27, 28) for processing the signals from the measuring sensors of the measuring facility (7), the measuring facility (7) being designed to be dipped into the pool of the reactor down to the level of the spacer-grid (3) on which the measurements are being carried out and the signal processing means (27, 28) being arranged above the upper level of the pool in which the fuel assembly (1) is arranged.

8. Device according to claim 7, characterized in that the signal processing facility (28) comprises a unit (29) for acquiring and processing signals from the electromagnetic sensor (24) and a computer (33) for making use of the signals.

9. Device according to any one of claims 4 and 5, characterized in that, in addition, it comprises means (27, 35) for displaying and controlling the displacements of the measuring tool (10).

10. Device according to claim 6, characterized in that the measuring facility (7) comprises video cameras (13, 14) for displaying the jaws (15b, 15c) of the measuring tool (10) and for viewing a central rod of the fuel assembly (1).

11. Device according to any one of claims 4 and 5, characterized in that, in addition, it comprises a probe (31) for measuring the temperature in the pool, in the vicinity of the spacer-grid (3) of the fuel assembly (1), said probe being connected to the facility (28) for processing signals from the electromagnetic sensor (24).
